(19) United States
(12) Patent Application Publication
(10) Pub. No.: US 2023/0075055 A1
(43) Pub. Date: Mar. 9, 2023

(54) METHOD AND SYSTEM FOR PROVIDING LIFE CYCLE ALERT FOR FLASH MEMORY DEVICE

(71) Applicant: Quanta Computer Inc., Taoyuan City (TW)

(72) Inventors: Jhao-Han CHEN, Taoyuan City (TW); Yen-Ping TUNG, Taoyuan City (TW)

(21) Appl. No.: 17/447,159

(22) Filed: Sep. 8, 2021

(51) Int. Cl. G06F 3/06

(52) U.S. Cl. CPC G06F 3/0653; G06F 3/0604; G06F 3/0679

(57) ABSTRACT

A system to monitor the condition of a flash memory device such as flash memory devices that store hardware settings for a BIOS or system logs in a computer system is disclosed. The flash memory device is controlled by a flash memory driver. A controller provides a command via a file system to write data to the flash memory driver. A flash memory module interfaces with the flash memory driver. The flash memory module is configured to determine whether the command to write data requires a block erase of the flash memory device. The flash memory module determines an erase time from when a command to erase a block is sent to when a status of write ready is sent by the flash memory device.

### TECHNICAL FIELD

The present disclosure relates generally to monitoring the condition of a flash memory device. More particularly, aspects of this disclosure relate to a system that monitors flash memory deterioration by determining whether erase times exceed a threshold time value.

### BACKGROUND

Computer systems (e.g., desktop computers, blade servers, rack-mount servers, etc.) are employed in large numbers in various applications. Computer systems may perform general computing operations. A typical computer system such as a server generally includes hardware components such as processors, memory devices, network interface cards, power supplies, and other specialized hardware.

Servers are employed in large numbers for high demand applications such as network based systems or data centers. The emergence of the cloud for computing applications has increased the demand for data centers. Data centers have numerous servers that store data and run applications accessed by remotely-connected, computer device users. A typical data center has physical chassis structures with attendant power and communication connections. Each rack may hold multiple computing servers and storage servers. Each individual server has multiple identical hardware components such as processors, storage cards, network interface controllers, and the like.

Computer systems such as servers have a basic input/output system (BIOS) that is typically stored in a Serial Peripheral Interface (SPI) EEPROM flash memory device and executed by the processor during start-up of the computer system. The BIOS is used to test basic inputs and outputs from the hardware components before booting up the computer system. The BIOS may have certain settings for the various hardware components in the computer systems. Settings for hardware components as well as BIOS firmware (the BIOS image), are typically stored on the flash memory device on the motherboard. In complex computer systems, there are many settings that users may select for different hardware components. The settings are accessed by the BIOS executed by the processor during system start-up. The settings may be changed based on user preference and upgrades to hardware components on the computer system.

Servers also use a baseboard management controller (BMC) to manage background operations such as power and cooling. The BMC collects data on the operation of the computer system in various logs. For example, data relating to different hardware components is stored in a system event log (SEL) that may also be written on the flash memory device. Thus, the embedded system firmware also saves system execution logs which are helpful for a vendor to analyze the system status when faults occur. Hence, a computer system relies on reliable non-volatile memory devices such as flash memory devices to store both hardware settings and log data.

Traditionally, the settings or logs are stored as files in the file system in Linux. A typical flash memory device is divided into memory blocks. In order to write to a particular block, the block must be erased. The erase process allows monitoring of all file system erase actions relating to the flash memory device.

Flash memory devices have a superior price-performance ratio, and thus a flash memory device is typically used by computer systems and corresponding firmware to store settings and system logs. However, flash memory devices suffer from having a limited number of erases and writes that may be performed before the flash memory device fails. Typically, the number of allowable block erases in a flash memory device is defined by a vendor specification. The block erase time becomes longer as more erases are performed. The performance of firmware for a computer system may be impacted by the longer erase time as it takes longer for settings and logs to be updated. When a flash memory device storing the settings or logs fails, the computer system can be rendered inoperable.

Thus, there is a need for a method to monitor the block erase time of a flash memory device to determine the condition of the flash memory device. There is also a need for a system that determines block erase time of a flash memory by determining the time between a command to erase and the sending of a write ready status. There is also a need for a system that provides a user alert on the degradation of flash memory performance to allow a user to replace the flash memory.

### SUMMARY

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

According to certain aspects of the present disclosure, a system to monitor the condition of a flash memory device is disclosed. The flash memory device is controlled by a flash memory driver. A controller provides a command via a file system to write data to the flash memory driver. A flash memory module interfaces with the flash memory driver. The flash memory module is configured to determine whether the command to write data requires a block erase of the flash memory device. The flash memory module determines an erase time from the time between sending a command to erase a block and a write ready status is sent by the flash memory device.

A further implementation of the example system is an embodiment where the controller is a baseboard management controller. Another implementation is where the file system is the Journaling Flash File System version 2 (JFFS2). Another implementation is where the data is hardware settings for hardware components of a computer system. Another implementation is where the flash memory device stores a basic input/output system (BIOS). Another implementation is where the data is updates to a system log. Another implementation is where the controller is further configured to store the erase time of the block in a user space. Another implementation is where the controller is operable to compare the erase time with a threshold erase time value and issue a notification if the erase time exceeds the threshold erase time value. Another implementation is where the notification includes activating a visual indicator. Another implementation is where the notification includes sending a message to a remote station via a network.

Another disclosed example is a computer system including a processor executing a basic input/output system (BIOS) and a baseboard management controller (BMC). The BMC provides a command via a file system to write operational data from the computer system. The computer system includes a BMC flash memory device controlled by a flash memory driver. A flash memory module interfaces with the flash memory driver. The flash memory module is configured to determine whether the command to write operational data requires a block erase of the BMC flash memory device. The flash memory module determines an erase time from the time between sending a command to erase a block and a write ready status is sent by the flash memory device.

A further implementation of the example computer system is an embodiment where the file system is the Journaling Flash File System version 2 (JFFS2). Another implementation is where the computer system includes a BIOS flash memory device storing the BIOS and hardware settings for hardware components of the computer system. The baseboard management controller provides commands via the file system to write hardware settings to a second flash memory driver interfacing with the BIOS flash memory device. The computer system includes a second flash memory module interfacing with the flash memory driver. The second flash memory module is configured to determine whether the command to write hardware settings requires a block erase of the BIOS flash memory device. The second flash memory module determines an erase time by the time between a command to erase a block and a write ready status is sent by the BIOS flash memory device. Another implementation is where the operational data is updates to a system log. Another implementation is where the controller is further configured to store the erase time of the block in a user space. Another implementation is where the controller is operable to compare the erase time with a threshold erase time value and issue a notification if the erase time exceeds the threshold erase time value. Another implementation is where the notification includes activating a visual indicator. Another implementation is where the notification includes sending a message to a remote station via a network.

Another disclosed example is a method of monitoring the status of a flash memory device. A write command is received from a controller via a file system to write data to the flash memory device. It is determined whether a block of the flash memory is required to be erased to perform the command. A block erase of the flash memory device is initiated via a flash memory driver. A write ready status is sent from the flash memory device when the block erase is complete. The flash memory module determines an erase time by determining the time between initiating the erase command to erase a block and the time when the write ready status is received.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims. Additional aspects of the disclosure will be apparent to those of ordinary skill in the art in view of the detailed description of various embodiments, which is made with reference to the drawings, a brief description of which is provided below.

### BRIEF DESCRIPTION OF THE DRAWINGS

The disclosure, and its advantages and drawings, will be better understood from the following description of representative embodiments together with reference to the accompanying drawings. These drawings depict only representative embodiments, and are therefore not to be considered as limitations on the scope of the various embodiments or claims.

FIGS. 1A-1B are a block diagram of a computer system using flash memories for firmware functions including hardware settings and system logs, according to certain aspects of the present disclosure;

FIG. 2 is a diagram of the interaction between the BMC and the flash memory to determine the erase time of the flash memory, according to certain aspects of the present disclosure;

FIG. 3 is a flow diagram of a routine executed by the BMC to determine the erase time of the flash memory, according to certain aspects of the present disclosure; and

FIG. 4 is a flow diagram of the routine to alert a user of a failing flash memory device, according to certain aspects of the present disclosure.

### DETAILED DESCRIPTION

Various embodiments are described with reference to the attached figures, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, can be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

The present disclosure relates to a routine that determines the start time for an erase operation and the time when a write ready status is received from a flash memory device. The routine determines the erase time of the flash memory based on the start time and when the ready status is received. The flash memory is used to store hardware settings and system logs that facilitate the operation of a computer system. Based on a comparison of the determined erase time with a vendor specification erase time, the routine can issue a user alert indicating the performance of the flash memory device is degrading. In this manner, the flash memory device may be replaced before effecting the performance of the computer system.

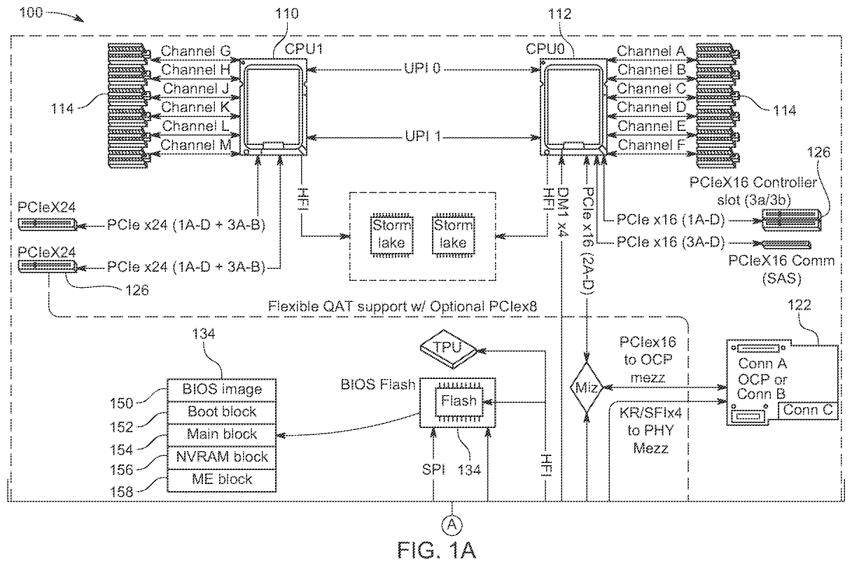

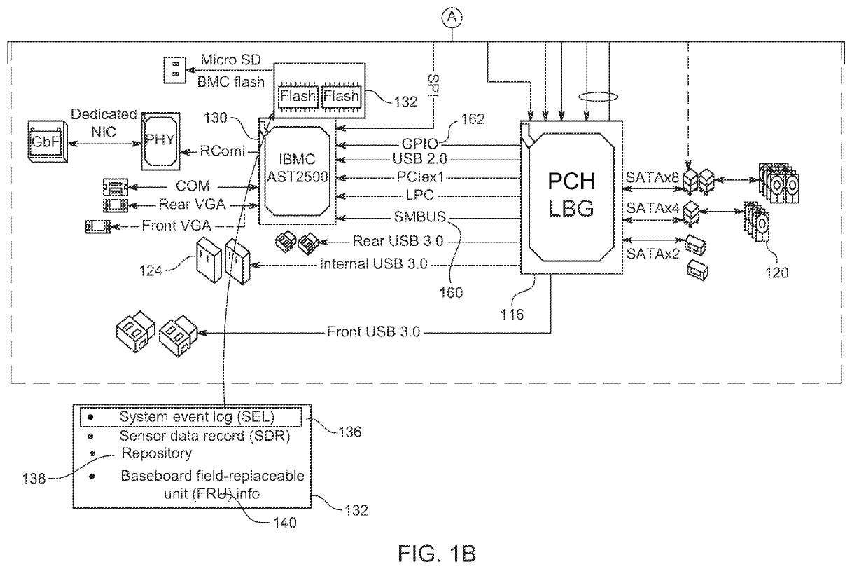

FIGS. 1A-1B are a block diagram of the components of a computer system 100 that runs a routine to insure reliability of flash memories that store hardware settings and system logs. In this example, the computer system 100 is a server, but any suitable computer device can incorporate the principles disclosed herein. The computer system 100 has two central processing units (CPU) 110 and 112. The two CPUs 110 and 112 have access to dual in line memory modules (DIMMs) 114. Although only two CPUs are shown, additional CPUs may be supported by the computer system 100. Specialized functions may be performed by specialized processors such as a GPU or a field programmable gate array (FPGA) mounted on a motherboard or on an expansion card in the computer system 100.

A platform controller hub (PCH) 116 facilitates communication between the CPUs 110 and 112 and other hardware components such as serial advanced technology attachment (SATA) devices 120, Open Compute Project (OCP) devices 122, and USB devices 124. The SATA devices 120 may include hard disk drives (HDD)s. Alternatively, other memory storage devices such as solid state drives (SSD)s may be used. Other hardware components such as PCIe devices 126 may be directly accessed by the CPUs 110 or 112 through expansion slots (not shown). The additional PCIe devices 126 may include network interface cards (NIC), redundant array of inexpensive disks (RAID) cards, field programmable gate array (FPGA) cards, and processor cards such as graphic processing unit (GPU) cards.

A baseboard management controller (BMC) 130 manages operations such as power management and thermal management for the computer system 100. The BMC 130 has access to a dedicated BMC memory device 132 that is a flash memory device. A separate basic input output system (BIOS) memory device 134 is another flash memory device. Both the flash memory devices 132 and 134 may be accessed through the PCH 116 and monitored by the BMC 130.

In this example, the BMC flash memory device 132 stores system logs 136, a sensor data record 138, and a BMC field replacement unit (FRU) information record 140. The BIOS flash memory device 134 may include a BIOS image 150, a boot block 152, a main block 154, a non-volatile random access memory (NVRAM) block 156, and a management engine (ME) block 158. The blocks in the BIOS flash memory device 134 facilitate the start-up routine for the computer system 100. The NVRAM block 156 thus includes settings that may be selected by a user for the different hardware components of the computer system 100.

In this example, the BMC 130 communicates with the PCH 116 through different channels 160 that may include SMbus, LPC, PCIe, Serial Peripheral Interface (SPI) bus, and USB lines. The PCH 116 includes a series of general purpose input/output pins (GPIO) 162 for communicating with the BMC 130. A series of lines in the SPI bus allow for communication with the BIOS flash memory device 134. The BMC 130 includes firmware that receives different messages from hardware components in the computer system 100. The messages are stored in system logs 136. For example, the system logs 136 may include a system event log (SEL) or a BMC console log.

The BMC 130 executes a routine to monitor the block erase times of the flash memory devices 132 and 134 used to store settings and record system logs. The routine reads the block erase times and uses this value to evaluate the status of the flash memories.

A flash driver executed by the BMC 130 manages reads and writes for the flash memory devices 132 and 134. In this example, the flash driver sends the erase command to the flash memory. The erase action of a flash memory device needs some time to be performed. The flash driver monitors the flash memory status until the status is indicated as flash available for writing. The flash driver thus determines the time between when the erase command sent and when the flash memory device is available to determine the erase time of the flash. A routine executed by the BMC 130 then determines whether the erase time is indicative of degradation of the flash memory.

The settings and logs are stored as files and managed by the file system in the Linux operating system. The file system may be based on the MTD (Memory Technology Devices) file in Linux that interacts with flash memory devices. Of course of other file types and systems may be used. In this example, the file system is the Journaling Flash File System version 2 (JFFS2), a log-structured file system for use with flash memory devices in Linux. The file system is based on the MTD (Memory Technology Devices) protocol, which is an abstraction layer created by a MTD module. The MTD module performs all of the file system actions in relation to the flash memory device. The MTD module monitors the erase actions for the flash memory device.

The erase action is implemented by the physical layer flash driver in the MTD module. The flash driver sends the erase command to the flash and waits for the command to be performed by the flash memory device. The waiting time until the flash memory is ready for writing can be seen as the flash erase time. The flash erase time may be stored in the kernel space accessible through Linux for a user space query. Such a query may be made by an application for determining whether an alert may be sent to a user to indicate a degrading flash memory.

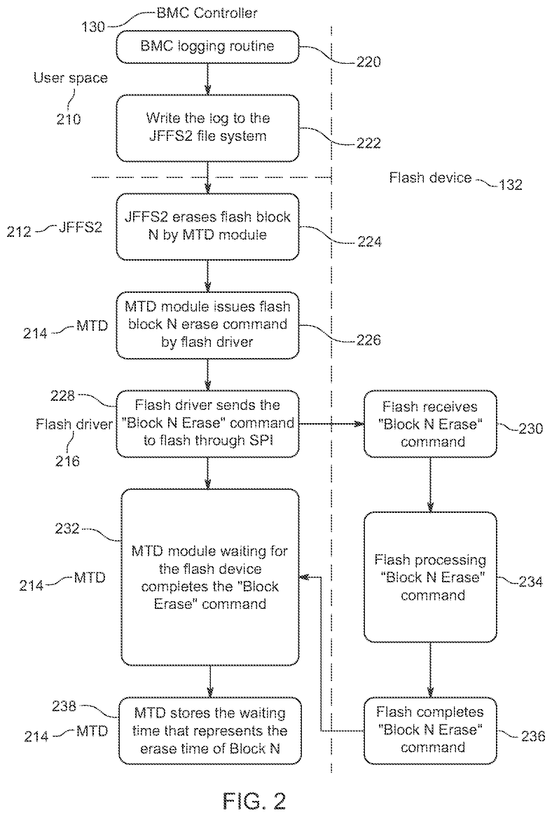

FIG. 2 is a diagram showing the process of erasing the flash memory device 132 executed by the BMC 130 when storing log entries. The BMC 130 facilitates access to a user space 210 for a user to read and write data. The BMC 130 interacts with a log structure file system 212 such as the JFFS2, a MTD module 214, and a flash driver 216.

The BMC 130 executes a logging routine 220 when data is received from a sensor in the computer system 100 or other data is communicated that requires logging. The logging routine 220 records operational data in logs such as the system event log, or the BMC console log. The logging routine 220 writes the log to the JFFS2 file system 212 (222). The JFFS2 file system 212 erases a flash memory block designated by the MTD module 214 (224). The MTD module 214 then issues a flash block erase command to the flash driver 216 for the designated block (226). The flash driver 216 sends the block erase command to the flash through the SPI bus in FIGS. 1A-1B (228). The flash memory device 132 receives the block erase command from the flash driver 216 (230). The MTD module 214 stores the time the erase command is sent and waits for the flash memory device 132 to complete the block erase command (232). The flash memory device 132 processes the block erase command to erase the designated block (234). The flash memory device 132 completes the block erase command and sends a write ready status to the MTD module 214 (236). The MTD module determines the waiting time between the sent erase block command and the receipt of the write ready status, that represents the erase time of the flash memory device 132 (238). The BMC 130 then initiates the writing of the log in the designated block in the flash memory device 132.

A similar process to that in FIG. 2 is employed by the BMC 130 when a block is required for writing new settings in the BIOS flash memory device 132 in FIGS. 1A-1B. In this manner, the Linux operating system stores the erase times from the flash memory devices 132 and 134 in user space accessible by the BMC 130.

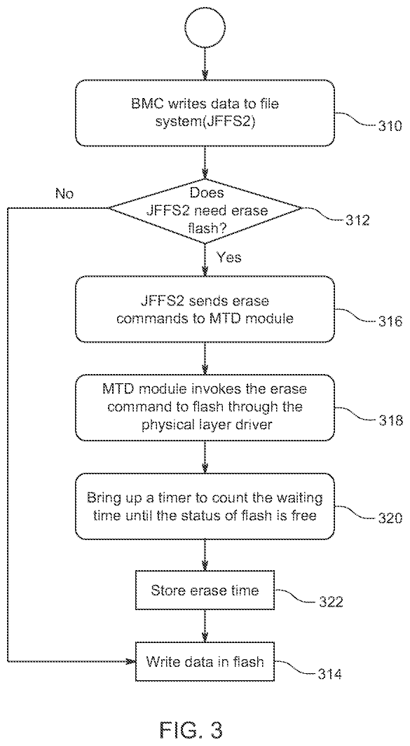

FIG. 3 is a flow chart of the erase time determination routine executed by the BMC 130 in FIGS. 1A-1B. The BMC 130 writes data to the JFFS2 such as log entries or settings (310). The routine determines whether the JFFS2 needs to erase the flash memory device to store the new write data (312). If the routine determines that no erase is necessary (310), the BMC 130 then proceeds to write the log or settings in a block of the flash memory device designated by the MTD module (314).

If the JFFS2 determines that a block of the flash must be erased for storing the new data, the JFFS2 sends an erase command to the MTD module (316). The MTD module invokes the erase command to the flash memory via the physical layer flash driver (318). The MTD module accesses a timer to count the waiting time until the status of the flash drive is changed to write ready (320). The time is then stored as the erase time (322). The BMC 130 then proceeds to write the log or settings in a block of the flash memory device designated by the MTD (314).

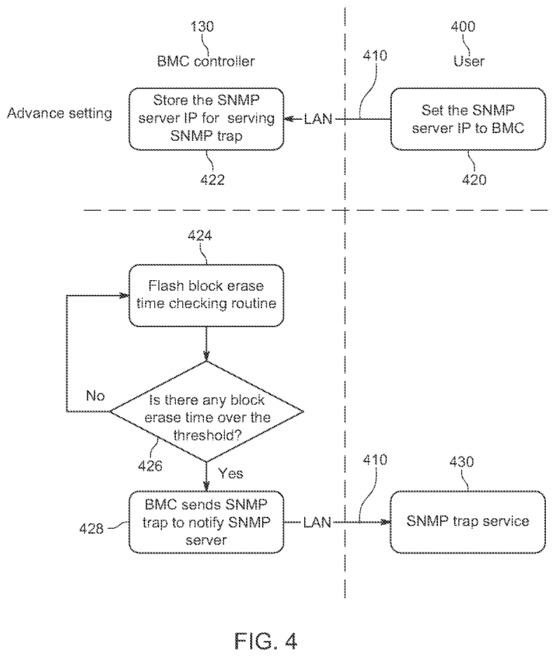

FIG. 4 shows the process followed by a high level application that is executed by the BMC 130 to read the stored erase times in the user space and alert a user if a flash memory device is degrading. The high level application can regularly read the erase times determined by the MTD module 214 in FIG. 2. The high level application determines whether the erase time is abnormal based on a comparison with the erase time in a vendor specification of the flash memory device. When the erase time is abnormal, the high level application issues an alert to the user.

In this example, the BMC 130 communicates with a remote user station 400 via a network 410. The remote user station 400 may be a management station for monitoring multiple servers in a data center. In this example, the remote user station 400 sets up an IP address for a Simple Network Management Protocol (SNMP) server and sends the IP address to the BMC 130 over the network 410 (420). The BMC 130 stores the SNMP server IP address for operating a SNMP trap routine (422). The SNMP trap routine allows an unsolicited message sent from the BMC 130 to the user station 400 to alert an administrator in case an important event happens.

The BMC 130 runs the high level application that checks the stored erase time each time a block is erased in a flash memory device (424). Alternatively, the application may monitor each erase time that is stored in the kernel space. The erase times for a block are determined each time the block is erased by the routine in FIG. 3 and stored in the user space. Thus, each block has an associated erase time. The routine determines whether there is any block erase time exceeding the threshold erase time specified by the vendor of the flash memory device (426). If none of the blocks have a block erase time exceeding the threshold value, the routine loops back and waits for the next erase time determination.

If a block has an erase time exceeding the threshold value, the BMC 130 sends a SNMP trap to notify the SNMP server over the network 410 (428). The SNMP server activates the trap and notifies the user of a trap message that indicates the flash device is degrading in performance (430). The administrator may then replace the degrading flash memory device.

The alert method may be implemented in other means. For example, the BMC 130 may create an entry in a warning log for later examination by a user. The log may be in accordance with the IPMI (Intelligent Platform Management Interface) standard to add an entry to the SEL (System Event Log). The BMC 130 may also activate a physical indicator such as an LED on the computer system 100.

The BMC 130 may also issue an alert message relating to the flash device using other protocols. One example of the process for issuing an alert message is PEF (Platform event filtering) that provides a mechanism for configuring the BMC to take selected actions on event messages that it receives. Another alternative may be sending an E-mail to a system operator. Another alternative may be use of the Redfish event service

The above described routines in FIGS. 3-4 are representative of example machine-readable instructions for the BMC 130 in FIGS. 1A-1B to determine erase times and determine whether the flash memory is degrading. In this example, the machine-readable instructions comprise an algorithm for execution by: (a) a processor; (b) a controller; and/or (c) one or more other suitable processing device(s). The algorithm may be embodied in software stored on tangible media such as flash memory, CD-ROM, floppy disk, hard drive, digital video (versatile) disk (DVD), or other memory devices. However, persons of ordinary skill in the art will readily appreciate that the entire algorithm and/or parts thereof can, alternatively, be executed by a device other than a processor and/or embodied in firmware or dedicated hardware in a well-known manner (e.g., it may be implemented by an application specific integrated circuit (ASIC), a programmable logic device (PLD), a field programmable logic device (FPLD), a field programmable gate array (FPGA), discrete logic device, etc.). For example, any or all of the components of the routines can be implemented by software, hardware, and/or firmware. Also, some or all of the machine-readable instructions represented by the flowcharts may be implemented manually. Further, although the example routine is described herein, persons of ordinary skill in the art will readily appreciate that many other methods of implementing the example machine-readable instructions may alternatively be used.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

While various embodiments of the present disclosure have been described above, it should be understood that they have been presented by way of example only, and not limitation. Numerous changes to the disclosed embodiments can be made in accordance with the disclosure herein, without departing from the spirit or scope of the disclosure. Thus, the breadth and scope of the present disclosure should not be limited by any of the above described embodiments. Rather, the scope of the disclosure should be defined in accordance with the following claims and their equivalents.

What is claimed is:

1. A system to monitor a flash memory device condition, the system comprising:
a flash memory device controlled by a flash memory driver;
a controller providing a command via a file system to write data to the flash memory driver; and
a flash memory module interfacing with the flash memory driver, the flash memory module being configured to determine if the command to write data requires a block erase of the flash memory device, and determine an erase time from the time between: a) sending a command to erase a block, and b) when a write ready status is sent by the flash memory device.

2. The system of claim 1, wherein the controller is a baseboard management controller.

3. The system of claim 1, wherein the file system is the Journaling Flash File System version 2 (JFFS2).

4. The system of claim 1 wherein the data is hardware settings for hardware components of a computer system.

5. The system of claim 4, wherein the flash memory device stores a basic input/output system (BIOS).

6. The system of claim 1, wherein the data is updates to a system log.

7. The system of claim 1, wherein the controller is further configured to store the erase time of the block in a user space.

8. The system of claim 1, wherein the controller is operable to:
compare the erase time with a threshold erase time value; and
issue a notification if the erase time exceeds the threshold erase time value.

9. The system of claim 8, wherein the notification includes activating a visual indicator.

10. The system of claim 8, wherein the notification includes sending a message to a remote station via a network.

11. A computer system comprising:
a processor executing a basic input/output system (BIOS);
a baseboard management controller (BMC) providing a command via a file system to write operational data from the computer system;
a BMC flash memory device controlled by a flash memory driver; and
a flash memory module interfacing with the flash memory driver, the flash memory module being configured to determine if the command to write data requires a block erase of the flash memory device, and determine an erase time from the time between: a) sending a command to erase a block, and b) when a write ready status is sent by the flash memory device.

12. The computer system of claim 11, wherein the file system is the Journaling Flash File System version 2 (JFFS2).

13. The computer system of claim 11, further comprising:
a BIOS flash memory device storing the BIOS and hardware settings for hardware components of the computer system, wherein the baseboard management controller provides commands via the file system to write hardware settings to a second flash memory driver, the second flash memory driver interfacing with the BIOS flash memory device; and
a second flash memory module interfacing with the flash memory driver, wherein the second flash memory module is configured to determine whether the command to write hardware settings requires a block erase of the BIOS flash memory device, the second flash memory module further determining an erase time by the time between a command to erase a block and when a write ready status is sent by the BIOS flash memory device.

14. The computer system of claim 11, wherein the operational data is updates to a system log.

15. The computer system of claim 11, wherein the BMC is further configured to store the erase time of the block in a user space.

16. The computer system of claim 11, wherein the BMC is operable to compare the erase time with a threshold erase time value and issue a notification if the erase time exceeds the threshold erase time value.

17. The computer system of claim 16, wherein the notification includes activating a visual indicator.

18. The computer system of claim 16, wherein the notification includes sending a message to a remote station via a network.

19. A method of monitoring the condition of a flash memory device, the method comprising:
receiving a write command from a controller via a file system to write data to the flash memory device;
determining whether a block of the flash memory is required to be erased to perform the command;
initiating a block erase of the flash memory device via a flash memory driver;
sending a write ready status from the flash memory device when the block erase is complete; and
determining via a flash memory module an erase time based on a time between initiating the block erase and when the write ready status is received.
